(19) United States
(12) Patent Application Publication
(10) Pub. No.: US 2007/0182662 A1
(43) Pub. Date: Aug. 9, 2007

(54) Portable electronic advertising system and method of use

(76) Inventors: Rostislav Alpin, Brooklyn, NY (US); Gregory Davidzon, Brooklyn, NY (US)

Correspondence Address: JAMES RAY & ASSOCIATES, 2640 PITCAIRN ROAD, MONROEVILLE, PA, 15146, US

(21) Appl. No.: 11/445,877

(22) Filed: Jun. 2, 2006

Related U.S. Application Data
(60) Provisional application No. 60/765,795, filed on Feb. 7, 2006.

(51) Int. Cl. G09G 5/00

(52) U.S. Cl. 345/1.1

(57) ABSTRACT

A portable electronic advertising system for delivering targeted advertising content include a display and a controller coupled to the display. The controller is capable of processing predetermined advertising information to be displayed on the display, wherein the predetermined advertising information is either stored within the memory module or is wirelessly uploaded. A power supply is provided for operating the display and the controller. A mounting assembly is attached to the display for mounting it at a predetermined height for viewing by at least one person. The power supply and the controller are supported above the hips of a human carrier.

### CROSS-REFERENCE TO RELATED APPLICATIONS

This application is related to and claims priority from Provisional Patent Application Ser. No. 60/765,795 filed Feb. 7, 2006.

### FIELD OF THE INVENTION

The present invention relates, in general, to electronic advertising systems and, more particularly, this invention relates to a portable electronic advertising system capable of being carried by a human carrier.

### BACKGROUND OF THE INVENTION

Prior to the conception and development of the present invention, as is generally known in the art, targeted advertising by merchants or other organizations which is tailored to a preselected segment of the general public increases overall effectiveness of the advertising while decreases the delivery costs. Traditionally, stationary or electronic billboards have been utilized to deliver such targeted advertising. However, such advertising is disadvantaged by the stationary nature of the billboards.

Lately, dynamic advertising systems have been employed for delivering targeted advertising. U.S. Pat. No. 6,853,012 to Dodd discloses a portable display system carried by a person for displaying a message at an elevation above the person. While such system improves the delivery of the targeted advertising content, the system requires a plurality of battery sources worn about the hips of the user and, subsequently, increases the weight of the overall system.

U.S. Pat. No. 6,898,517 to Froeberg teaches a vehicle-based dynamic advertising method and a system which is displayed by a moving vehicle according to the location and direction of travel. However, such advertising only reaches the segment of the general public which is situated in close proximity to a moving vehicle.

### SUMMARY OF THE INVENTION

According to a first embodiment, the present invention provides a portable electronic advertising system. The portable electronic advertising system includes a display and a control means coupled to such display. The control means is capable of processing predetermined advertising information to be displayed on the display. A power supply is provided for operating such display and control means. There is a mounting assembly attached to the display for mounting it at a predetermined height for viewing by at least one person. The mounting assembly is at least one of stationary, tow able and capable of being carried by a human carrier. When the mounting assembly is carried by such human carrier, the control means and the power supply are positioned above the hips of such human carrier.

According to another embodiment of the invention, there is provided a method of delivering targeted advertising information. The method includes providing an electronic advertising system having a display, a control means coupled to the display, a power supply and a global positioning means coupled to the control means. Then, at least temporarily positioning the electronic advertising system in a predetermined geographical location. Next, selecting at least one targeted advertisement based on the predetermined geographical location. Finally, displaying, on the display, the at least one targeted advertisement.

According to a further embodiment, the present invention provides a method of interactively delivering targeted advertising information. Such method includes providing an electronic advertising system having a display, a control means coupled to the display and a power supply for operating the display and the control means. Then, at least temporarily positioning the electronic advertising system in a predetermined geographical location. Next, displaying, on the display, at least one preselected message associated with at least one targeted advertisement preselected for display based on the predetermined geographical location. Displaying, on the display, at least one instructional message in combination with the at least one preselected message for requesting the at least one targeted advertisement. Then, enabling at least one member of the public to request the at least one targeted advertisement. Next, receiving a request from such at least one member of the public. And finally, displaying, on the display, the at least one targeted advertisement in response to the received request.

### OBJECTS OF THE INVENTION

It is, therefore, one of the primary objects of the present invention to provide a portable electronic system for delivering targeted advertising content.

Another object of the present invention is to provide a portable electronic advertising system which is attachable to a human carrier.

Yet another object of the present invention is to provide a portable electronic advertising system which is attachable to a human carrier and which displays a targeted advertisement in both forward and rearward directions.

A further object of the present invention is to provide a portable electronic advertising system which is easily tow able.

Yet a further object of the present invention is to provide a method for delivering targeted advertising content based on a geographical location.

An additional object of the present invention is to provide an interactive method for delivering targeted advertising.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side elevation view of an electronic advertising system according to one embodiment of the present invention illustrating an attachment to a human carrier;

FIG. 2 is a schematic representation of the electronic advertising system of FIG. 1; and

FIG. 3 is a side elevation view of an electronic advertising system according to another embodiment of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

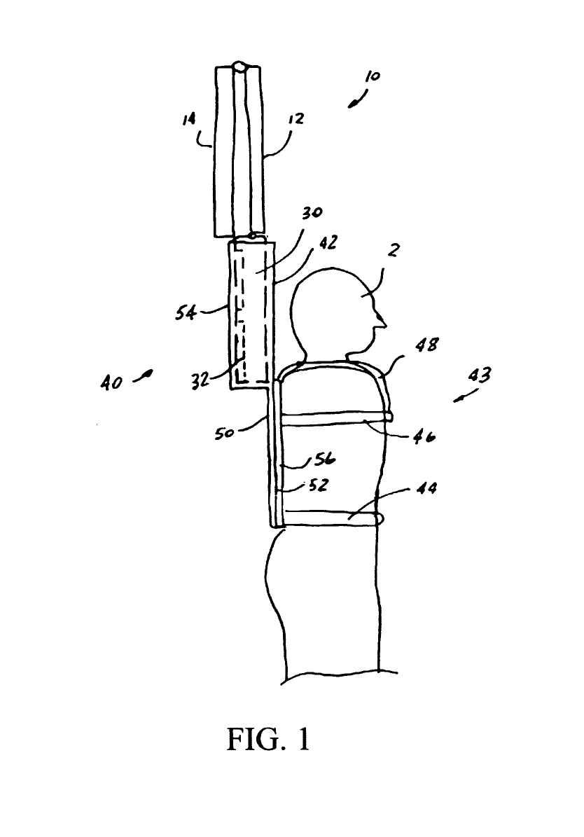

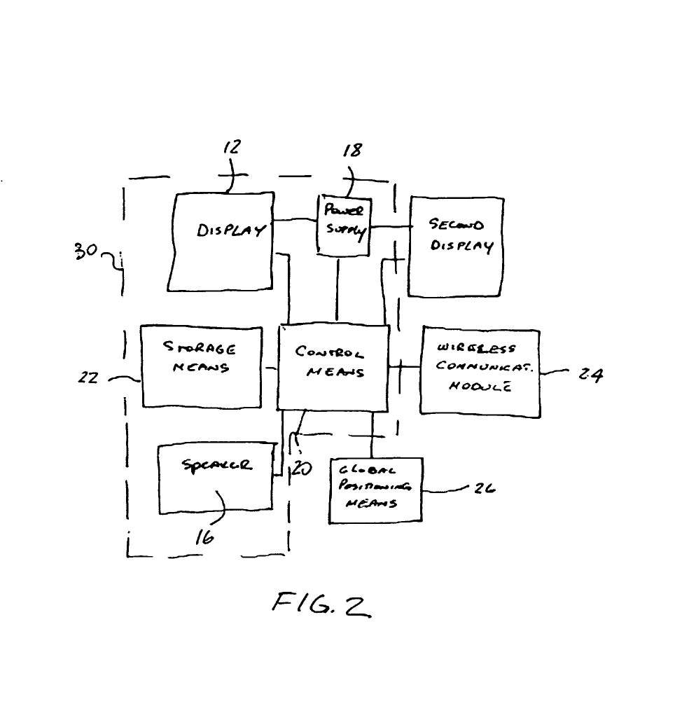

Reference is now made, to FIGS. 1-2, wherein there is shown a portable electronic advertising system, generally designated 10, according to one presently preferred embodiment of the invention. The electronic advertising system includes a display 12, a control means 20 coupled to the display 12 and capable of processing predetermined advertising information to be displayed on the display 12.

It is presently preferred that a storage means 22, such as a memory module, is coupled to the control means 20 and such predetermined advertising information is stored within the storage means 22. Alternatively, the electronic advertising system 10 may be adapted with a wireless communications means 24 which is coupled to the control means 20 and wherein such predetermined advertising information is wirelessly transmitted to the electronic advertising system 10.

A power supply 18 is provided to operate the display 12 and the control means 20. A mounting means, generally designated 40, is attached to the display 12 for mounting it at a predetermined height for viewing by at least one person. The mounting means 40 is attachable to a human carrier 2. The mounting means 40 further supports the control means 20 and the power supply 18 in a position above the hips of such human carrier 2. Such power supply 18 is at least one rechargeable battery.

The electronic advertising system 10 may further include a second display 14 mounted in a back-to-back relationship to the display 12. Advantageously, the second display 14 is coupled to control means 20 for displaying such predetermined advertising information in both rearward and forward directions as relates to a walking human carrier 2. Preferably, control means 20 is of a microprocessor type and includes processing and operating software algorithms. At least one speaker 16 is provided for audibly communicating the predetermined advertising information.

In the most presently preferred embodiment of the invention, the display 12, the control means 20 and the power supply 18 are disposed within a well known portable computer 30. Advantageously, portable computer 30 will also include at least one speaker 16, and power supply 18. Such portable computer 30 may further contain the second display 14 as taught, for example, by U.S. Pat. No. 6,667,878 to Ponx. The teaching of U.S. Pat. No. 6,667,878 is incorporated herein by reference thereto. Alternatively, a pair of portable computers 30 may be provided for displaying such predetermined advertising information in both rearward and forward directions.

The mounting means 40, employed for supporting the portable computer 30, includes a mounting member 42 attached to a harness means, generality designated 43. The harness means 43 includes a first belt 44 encircling the hips and a second belt 46 encircling the chest of the human carrier 2.

Preferably, mounting member 42 is a plate-like member. A pair of shoulder straps 48 may be provided for supporting the weight of the electronic advertising system 10. A cradle 54, preferably of a pocket type, is attached to a first surface 50 of the mounting member 42 for receiving a portion of the portable computer 30. The length of the mounting member 42 and position of the cradle 54 are preselected to enable placement of the display 12 above the head of the human carrier 2.

A pad 56, formed from a cushioned material, is attached to a second surface 52 of the mounting member 42 which is oriented towards the back of the human carrier 2. In order to reduce weight of the mounting means 40, the mounting member 42 is manufactured from a lightweight material such as an engineered plastic or aluminum. The harness means 43 and at least a portion of the mounting member 42 may be disposed within a well known backpack (not shown).

Alternative, the mounting means 40 may be at least partially constructed from light weight tubular materials in accordance with teachings of the U.S. Pat. No. 6,843,012 to Dodd, which are incorporated herein by reference thereto.

It will be appreciated that the mounting means 40, and particularly the cradle 54, may be adapted to receive a pair of portable computers 30 mounted in back-to back relationship for displaying such predetermined advertising information in both rearward and forward directions.

According to another embodiment, the invention provides a method of delivering targeted advertising information. In use, the human carrier 2 at least temporarily positions the electronic advertising system 10 in a predetermined geographical location and manipulates the control means 20 in order to select at least one predetermined advertising information associated with such predetermined geographical location and which is stored within the storage means 22 for displaying it on the display 12.

Preferably, there is a predetermined plurality or a set of advertising information selected for a particular geographical location. When the human carrier 2 walks to a new predetermined geographical location, such human carrier selects a new set of predetermined advertising information for display in such new geographical location. Such predetermined advertising information includes one of text message, graphics, animation, video, audio and various combinations thereof.

The electronic advertising system 10, may further include a global positioning means 26 coupled to the control means 20 and in communication with the satellite means (not shown) for defining such preselected geographical location. In such embodiment, the need for storage means 22 and the need for the human carrier 2 to manipulate the control means 20 are at least partially eliminated and the at least one predetermined advertising information is uploaded by way of wireless communication means 24 when the human carrier 2 reaches such preselected geographical location.

Alternatively, only updated advertising information may be uploaded and combined with the previously stored advertising information for display in such preselected geographical location. Advantageously, uploading of such at least one predetermined advertising information enables the up-to-date advertising information to be displayed on the display 12 and allows sponsors of such predetermined advertising information to effectively and efficiently incorporate changes.

The control means 20 may be adapted to generate statistical information associated with a number of occurrences that the at least one targeted advertisement is displayed. Control means 20 is further adapted to store such statistical information and, if required, communicate it to a remote location, such as a central network (not shown).

It will be understood, that the weight of the electronic advertising system 10 to be carried by a human carrier 2 is of critical importance and preferably, the display 12 is equal to or less than a 21 inch display, measured diagonally.

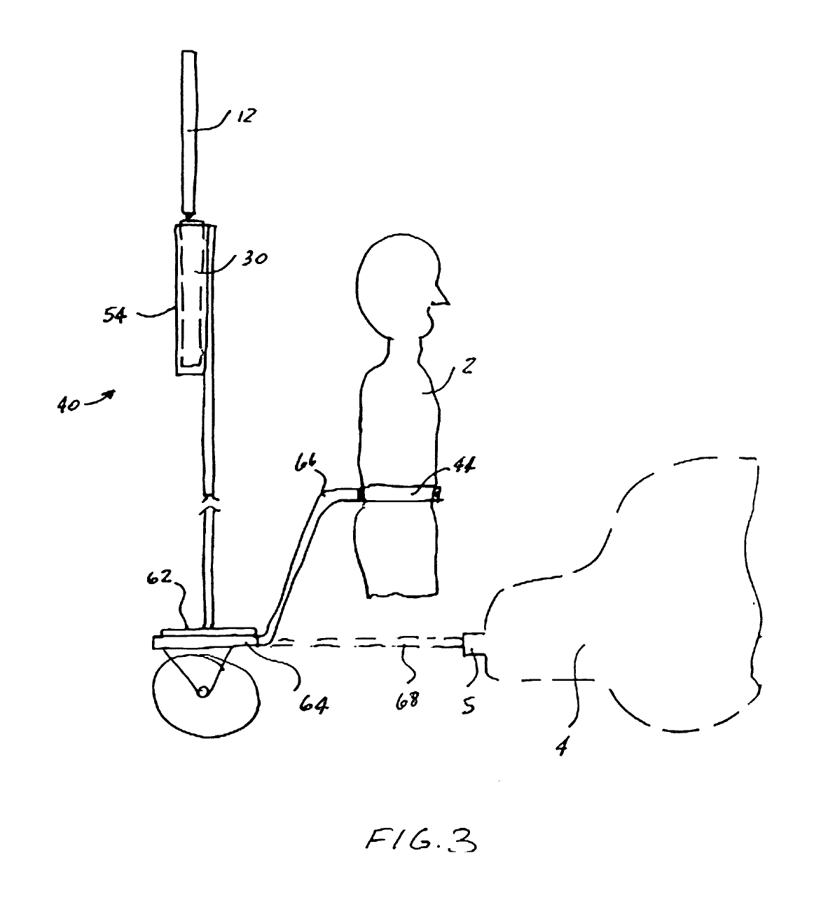

Now in reference to FIG. 3, there is shown another embodiment of the present invention, wherein the mounting means 40 includes an elongated member 60 disposed in a vertical position and wherein at least the display 12 is mounted to one end of the elongated member 60. A support base 62 is connected to the opposed end of the elongated member 60.

The support base 62 may be stationary or it may be attached to a wheeled cart means 64 for towing by one of a person 2 and a vehicle 4. For example, the human carrier 2 may push or pull on the handle 66 which extends upwardly from the cart 64 or the handle 66 may be connected to a belt portion 44 worn by the person 2.

Alternatively, a handle 68 which extends outwardly and generally horizontally from the cart 64 may be attached to a tow bar 5 of vehicle 4. It will be appreciated that the vehicle 4 may be a bicycle. It will be understood that display 12 is tow able or stationary supported and may be greater than the 21 inch screen.

According to another embodiment of the invention, there is provided a method of interactively delivering targeted advertising information. Such method includes providing a portable electronic device having a display, a control means coupled to the display and a power supply for operating the display and the control means. Then, at least temporarily positioning the portable electronic device in a predetermined geographical location. Next, displaying, on the display, at least one preselected message associated with at least one targeted advertisement available for display based on the predetermined geographical location. Displaying, on the display, at least one instructional message in combination with the at least one preselected message for requesting the at least one targeted advertisement. Then, enabling at least one member of the public to request the at least one targeted advertisement. Next, receiving the request from such at least one member of the public. And finally, displaying, on the display, the at least one targeted advertisement in response to the received request.

Such instructional message may include an instruction to dial at least one phone number displayed in combination with the instructional message. When the member of the public dials the at least one displayed phone number, the control means receive a signal associated with the at least one dialed phone number and trigger the control means to display the at least one targeted advertisement. It will be appreciated that since cell phones are now widely in use, the at least one member of the public will be able to simply and conveniently request such at least one targeted advertising information.

Advantageously, when the electronic advertising system 10 includes a portable computer 30, the at least one member of the public may be instructed to operate a keyboard of the cell phone in order to display at least one targeted advertisement.

Alternatively, electronic advertising system 10 may be connected to the Internet and the instructional message may include an instruction to access a preselected web site. Such access may be achieved by way of a portable electronic device such as cell phone or personal digital assistant (not shown).

Although the present invention has been shown in terms of the portable computer, it will be apparent to those skilled in the art, that the present invention may be applied to other portable electronic devices, such as a tablet personal computer, personal digital assistant, mobile phone and pager. For example, a personal digital assistant having a display screen of a sufficient size to be viewed from a distance may be utilized in place of the portable computer of the present invention.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A portable electronic advertising system comprising:
(a) a display;
(b) a control means coupled to said display and capable of processing predetermined advertising information to be displayed on said display;
(c) a power supply for operating said display and said control means; and
(d) a mounting means attached to said display for mounting it at a predetermined height for viewing by at least one person, said mounting means being at least one of stationary, tow able and carry able by a human carrier, wherein said mounting means carry able by such human carrier supports said control means and said power supply in a position above the hips of such human carrier.

2. The electronic advertising system, according to claim 1, wherein said electronic advertising system includes a storage means coupled to said control means and wherein such predetermined advertising information is stored within said storage means.

3. The electronic advertising system, according to claim 1, wherein said electronic advertising system further includes a wireless communications means coupled to said control means and wherein such predetermined advertising information is wirelessly transmitted to said electronic advertising system.

4. The electronic advertising system, according to claim 1, wherein said display, said control means and said power supply are disposed within a portable computer.

5. The electronic advertising system, according to claim 4, wherein said portable computer further includes a second display which is mounted in back-to-back relationship with said display.

6. The electronic advertising system, according to claim 1, wherein said electronic advertising system further includes a second display which is mounted in back-to-back relationship with said display, said second display being coupled to said control means for displaying such predetermined advertising information in a forward and a reward direction.

7. The electronic advertising system, according to claim 1, wherein said electronic advertising system further includes at least one speaker for audibly communicating said predetermined advertising information.

8. The electronic advertising system, according to claim 1, wherein said power supply is at least one rechargeable battery.

9. The electronic advertising system, according to claim 1, wherein said system further includes a global positioning means coupled to said control means and said preselected geographical location is defined by said global positioning means.

10. The electronic advertising system, according to claim 1, wherein said mounting means includes an elongated member disposed in a vertical position and at least said display is mounted to said elongated member.

11. The electronic advertising system, according to claim 10, wherein said mounting means further includes a support base connected to said elongated member.

12. The electronic advertising system, according to claim 11, wherein said support base is attached to a cart means tow able by one of a person and a vehicle.

13. The electronic advertising system, according to claim 1, wherein said mounting means includes a harness means removably attachable to a human carrier, wherein said display is attached to said harness means in a position which is elevated above such human carrier's head and wherein said control means and said power supply are mounted in a position above the hips of such human carrier.

14. A method of delivering targeted advertising information, said method comprising the steps of:
(a) providing an electronic advertising system having a display, a control means coupled to said display, and a power supply for operating said display and said control means;
(b) at least temporarily positioning said electronic advertising system in a predetermined geographical location;
(c) selecting at least one targeted advertisement based on said predetermined geographical location; and
(d) displaying, on said display, said at least one targeted advertisement selected in step (c).

15. The method, according to claim 14, wherein said method includes an additional step of attaching said electronic advertising system to a human carrier and at least temporarily positioning it in said predetermined geographical location by way of such human carrier.

16. The method, according to claim 14, wherein said method further includes a step of statistically counting a number of displays of said at least one targeted advertisement.

17. The method, according to claim 14, wherein said method further includes a step of providing a global positioning means for defining said predetermined geographical location.

18. The method, according to claim 14, wherein said at least one targeted advertisement includes one of text message, animation, graphics, video, audio and various combinations thereof.

19. The method, according to claim 14, wherein said portable electronic device includes a wireless communication means disposed therein and coupled to said control means and wherein said at least one targeted advertisement is wirelessly communicated to said control means.

20. A method of interactively delivering targeted advertising information, said method comprising the steps of:
(a) providing an electronic advertising system having a display, a control means coupled to said display and a power supply for operating said display and said control means;
(b) at least temporarily positioning said electronic advertising system in a predetermined geographical location;
(c) displaying, on said display, at least one preselected message associated with at least one targeted advertisement preselected for display based on said predetermined geographical location;
(d) displaying, on said display, at least one instructional message in combination with said at least one preselected message for requesting said at least one targeted advertisement;
(e) enabling at least one public member to request said at least one targeted advertisement;
(f) receiving a request from such at least one public member; and
(g) displaying, on said display, said at least one targeted advertisement in response to said request received in step (f).
